(19) United States
(12) Patent Application Publication
(10) Pub. No.: US 2026/0302766 A1
(43) Pub. Date: Oct. 1, 2026

(54) BLOCK SURGE PROTECTOR WITH TEMPERATURE COMPENSATION

(71) Applicant: WAYON SEMICONDUCTOR CO., LTD., Shanghai (CN)

(72) Inventors: Zhuangzhuang HAO, Shanghai (CN); Deyi ZHAO, Shanghai (CN); Wei ZHANG, Shanghai (CN); Qianwan JIANG, Shanghai (CN); Shijiao CUI, Shanghai (CN); Lin YAN, Shanghai (CN); Xiaoli GAO, Shanghai (CN); Yang PENG, Shanghai (CN); Yu MA, Shanghai (CN); Caixia ZHENG, Shanghai (CN)

(21) Appl. No.: 19/403,611

(22) Filed: Nov. 28, 2025

(30) Foreign Application Priority Data
Mar. 27, 2025 (CN) 2025103691067

(51) Int. Cl. H02H 9/04; H02H 1/04; H02H 9/00

(52) U.S. Cl. CPC H02H 9/04; H02H 1/04; H02H 9/005

(57) ABSTRACT

The invention provides a block surge protector with temperature compensation, and relates to the technical field of circuit protection, comprising a bidirectional surge protection circuit connected in series between two protected devices; the temperature compensation unit adjusts a collected voltage signal to match a threshold voltage of the enhanced NMOS transistor according to temperature change when generating a transient voltage so as to realize conduction, and further controls the depletion type NMOS transistor connected with a protected device to be turned off so as to realize surge blocking protection. The beneficial effects are that by introducing the temperature compensation unit, the protector can adjust the voltage signal according to temperature variations, so that the voltage signal is matched with the threshold voltage of the enhanced NMOS tube, and the stability of the trigger current is maintained. Even at extreme temperature, the trigger current can be kept close to normal temperature reference current, stable trigger current can be kept at different temperatures, fluctuation caused by temperature change is greatly reduced, and reliability and consistency of surge protection effect are guaranteed.

### FIELD OF THE INVENTION

The present invention relates to the technical field of circuit protection, and in particular, to a block surge protector with temperature compensation.

### DESCRIPTION OF THE RELATED ART

With the popularization of new energy vehicles and the development of automotive intelligence, electronic devices are widely used in vehicle internal control systems, auxiliary and comfort systems, safety systems, etc. These electronic devices are susceptible to surge impacts in the variable driving environment of vehicles. For instance, a sudden increase in battery voltage during engine startup may cause high-power surges. To effectively protect against these surge impacts, the Block Surge Protector (BSP) has emerged.

The BSP is connected in series to the protected unit. When a transient voltage occurs, it can enter a blocking state within an extremely short time, completely blocking the impact of overvoltage on the protected unit, thereby significantly enhancing the safety of automotive transient voltage protection. Currently, there are various design solutions for BSP circuits in the market. These solutions typically utilize semiconductor devices such as depletion NMOS transistors, current feedback field-effect transistors, or enhanced NMOS transistors to construct the basic framework of the blocking circuit, and achieve surge blocking protection by controlling the switching states of these devices.

However, existing BSP circuit technologies exhibit significant drawbacks, primarily reflected in the temperature stability of the trigger current. Specifically:

1. The trigger current fluctuates with temperature variations:

In the prior art, the trigger current of BSP circuits is often affected by temperature. Due to the specific temperature characteristics of semiconductor devices used in the circuit (such as current feedback field-effect transistors, enhanced NMOS transistors, etc.), the electrical parameters (such as on-resistance, threshold voltage, etc.) of these devices change with environmental temperature variations, leading to fluctuations in the trigger current. Specifically, when the temperature rises, the on-resistance of certain devices may increase, or the threshold voltage may decrease, causing the trigger current to decrease; conversely, when the temperature decreases, the trigger current may increase. This phenomenon of trigger current varying with temperature significantly impairs the surge protection performance of BSP circuits under different temperatures.

2. Affecting the reliability and consistency of surge protection:

Fluctuations in the trigger current lead to inconsistent surge protection performance of the BSP circuit at different temperatures. Under high or low temperature conditions, the trigger current may deviate from the design value, causing the BSP circuit to malfunction or significantly reducing its protection effectiveness. This poor temperature stability not only compromises the reliability of the BSP circuit but also diminishes its suitability in application scenarios with substantial environmental temperature variations, such as in automotive environments.

In summary, existing BSP circuit technologies exhibit the drawback of trigger current fluctuations with temperature variations, which severely affects their reliability and consistency in surge protection for automotive electronic devices. Therefore, developing a BSP circuit technology with improved temperature stability is of significant importance for enhancing the surge protection capability of automotive electronic devices.

### SUMMARY OF THE INVENTION

In view of the problems existing in the prior art, the invention provides block surge protector with temperature compensation, comprising:
a bidirectional surge protection circuit, wherein an input end and an output end of the bidirectional surge protection circuit are connected in series between the protected units;
a temperature compensation unit, wherein a signal acquisition terminal of the temperature compensation unit is connected in parallel across a source and a drain of a current feedback field-effect transistor in the bidirectional surge protection circuit, and a conduction control terminal of the temperature compensation unit is connected to a gate of an enhanced NMOS transistor in the bidirectional surge protection circuit, configured to adjust a collected voltage signal to match a threshold voltage of the enhanced NMOS transistor according to temperature variations when generating a transient voltage so as to realize conduction, and further to control a depletion NMOS transistor connected to the protected devices to turn off so as to realize surge blocking protection.

Preferably, the temperature compensation unit comprises:
a negative temperature coefficient device, one end of the negative temperature coefficient device is connected to one end of the current feedback field-effect transistor, and the other end of the negative temperature coefficient device is sequentially connected in series with a pull-up resistor and a voltage division resistor;
the other end of the current feedback field-effect transistor is connected to the voltage division resistor, and the gate of the enhanced NMOS transistor is connected to a connection point between the voltage division resistor and the pull-up resistor.

Preferably, the negative temperature coefficient device comprises a plurality of diodes with anodes and cathodes connected sequentially in series;
the cathode side of the diodes is connected to one end of the current feedback field-effect transistor, and the anode side of the diodes is connected to the pull-up resistor.

Preferably, the number of diodes is 1 to 3.

Preferably, the negative temperature coefficient device is a diode, or a transistor BE junction, or a transistor BC junction, or a negative temperature coefficient thermistor.

Preferably, the temperature compensation unit comprises:
a positive temperature coefficient device, one end of the positive temperature coefficient device is connected to one end of the current feedback field-effect transistor, and the other end of the positive temperature coefficient device is sequentially connected in series with a voltage division resistor and a pull-up resistor;
the other end of the current feedback field-effect transistor is connected to the pull-up resistor, and the gate of the enhanced NMOS transistor is connected to a connection point between the voltage division resistor and the pull-up resistor.

Preferably, the positive temperature coefficient device is a positive temperature coefficient thermistor, or a field-effect transistor on-resistance, or a metal film resistor, or a polysilicon resistor.

Preferably, the temperature compensation unit comprises:
a positive temperature coefficient thermistor, wherein two ends of the positive temperature coefficient thermistor are connected to a voltage division resistor and a pull-up resistor respectively;
one end of the current feedback field-effect transistor is connected to the pull-up resistor, the other end of the current feedback field-effect transistor is connected to the voltage division resistor, and the gate of the enhanced NMOS transistor is connected to a connection point between the positive temperature coefficient thermistor and the pull-up resistor.

Preferably, the depletion NMOS transistor in the bidirectional surge protection circuit comprises a first depletion NMOS transistor and a second depletion NMOS transistor;
a drain and a source of the current feedback field-effect transistor are connected to a source of the first depletion NMOS transistor and a source of the second depletion NMOS transistor respectively, a gate of the current feedback field-effect transistor is connected to a cathode of a first diode and a cathode of a second diode, an anode of the first diode is connected in series with a drain of the first depletion NMOS transistor via a first resistor, and an anode of the second diode is connected in series with a drain of the second depletion NMOS transistor via a second resistor;
the drain of the first depletion NMOS transistor and the drain of the second depletion NMOS transistor are connected to a protected device respectively.

Preferably, the enhanced NMOS transistor in the bidirectional surge protection circuit comprises a first enhanced NMOS transistor and a second enhanced NMOS transistor, and the temperature compensation unit comprises a first temperature compensation unit and a second temperature compensation unit;
a source of the first enhanced NMOS transistor and a source of the second enhanced NMOS transistor are connected to a drain and a source of the current feedback field-effect transistor respectively, a gate of the first enhanced NMOS transistor is connected to a conduction control terminal of the first temperature compensation unit, and a gate of the second enhanced NMOS transistor is connected to a conduction control terminal of the second temperature compensation unit;
a drain of the first enhanced NMOS transistor is connected to a gate of the first depletion NMOS transistor and one end of a third resistor, and the other end of the third resistor is connected to the source of the current feedback field-effect transistor;
a drain of the second enhanced NMOS transistor is connected to a gate of the second depletion NMOS transistor and one end of a fourth resistor, and the other end of the fourth resistor is connected to the drain of the current feedback field-effect transistor.

The above technical solution has the following advantages or beneficial effects:
by introducing a temperature compensation unit, the protector of the present invention can adjust the voltage signal according to temperature variations to match the threshold voltage of the enhanced NMOS transistor, thereby maintaining the stability of the trigger current. Even under extreme temperatures, the trigger current can remain near the room-temperature reference current, ensuring consistent trigger current across different temperatures. This significantly reduces fluctuations caused by temperature variations, thereby ensuring the reliability and consistency of surge protection performance.

### BRIEF DESCRIPTION OF THE DRAWINGS

FIG. 1 is a schematic structural diagram of a first BSP circuit in the prior art;

FIG. 2 is a schematic structural diagram of a second BSP circuit in the prior art;

FIG. 3 is a diagram showing the trigger current-temperature characteristics of the first BSP circuit and the second BSP circuit in the prior art;

FIG. 4 is a schematic structural diagram of a block surge protector with temperature compensation according to a preferred embodiment of the present invention;

FIG. 5 is a comparison diagram of trigger current-temperature characteristics between the present invention and the circuits in the prior art;

FIG. 6 is a schematic structural diagram of a block surge protector according to Embodiment 2 of the present invention;

FIG. 7 is a schematic structural diagram of a block surge protector according to Embodiment 3 of the present invention;

FIG. 8 is a schematic structural diagram of a block surge protector according to Embodiment 4 of the present invention;

FIG. 9 is a schematic structural diagram of a block surge protector according to Embodiment 5 of the present invention;

FIG. 10 is a schematic structural diagram of a block surge protector according to Embodiment 6 of the present invention.

### DETAILED DESCRIPTION

The present invention will be described in detail below with reference to the drawings and specific embodiments. The present invention is not limited to these embodiments, and other implementations falling within the scope of the essence of the present invention are also applicable.

In a preferred embodiment of the invention, based on the issues in the prior art, there is provided a block surge protector with temperature compensation.

### Embodiment 1

Referring to FIG. 4, a block surge protector with temperature compensation, comprising:
a bidirectional surge protection circuit 1, wherein bidirectional wiring terminals of the bidirectional surge protection circuit 1 are connected in series between two protected units 100;
a temperature compensation unit 2, wherein a signal acquisition terminal of the temperature compensation unit 2 is connected in parallel across a source and a drain of a current feedback field-effect transistor Q3 in the bidirectional surge protection circuit 1, and a conduction control terminal of the temperature compensation unit 2 is connected to a gate of an enhanced NMOS transistor Q4/Q5 in the bidirectional surge protection circuit 1, configured to adjust a collected voltage signal to match a threshold voltage of the enhanced NMOS transistor according to temperature variations when generating a transient voltage so as to realize conduction, and further controls a depletion NMOS transistor connected to the protected devices to turn off so as to realize surge blocking protection.

More specifically, the depletion NMOS transistor in the bidirectional surge protection circuit 1 comprises a first depletion NMOS transistor Q1 and a second depletion NMOS transistor Q2;
a drain and a source of the current feedback field-effect transistor Q3 are connected to a source of the first depletion NMOS transistor Q1 and a source of the second depletion NMOS transistor Q2 respectively, a gate of the current feedback field-effect transistor Q3 is connected to a cathode of a first diode D1 and a cathode of a second diode D2, an anode of the first diode D1 is connected in series with a drain of the first depletion NMOS transistor Q1 via a first resistor R1, and an anode of the second diode D2 is connected in series with a drain of the second depletion NMOS transistor Q2 via a second resistor R2;
The drain of the first depletion NMOS transistor Q1 and the drain of the second depletion-mode NMOS transistor Q2 are connected to a protected device 100 respectively.

More specifically, the enhanced NMOS transistor in the bidirectional surge protection circuit comprises a first enhanced NMOS transistor Q4 and a second enhanced NMOS transistor Q5, and the temperature compensation unit 2 comprises a first temperature compensation unit 21 and a second temperature compensation unit 22;
a source of the first enhanced NMOS transistor Q4 and a source of the second enhanced NMOS transistor Q5 are connected to a drain and a source of the current feedback field-effect transistor Q3 respectively (since it is a bidirectional surge protection circuit, they may also be connected with the drain and source of the current feedback field-effect transistor Q3 interchanged). A gate of the first enhancement-mode NMOS transistor Q4 is connected to a conduction control terminal of the first temperature compensation unit 21, and a gate of the second enhancement-mode NMOS transistor Q5 is connected to a conduction control terminal of the second temperature compensation unit 22;
A drain of the first enhanced NMOS transistor Q4 is connected to a gate of the first depletion NMOS transistor Q1 and one end of a third resistor R3, and the other end of the third resistor R3 is connected to a source of the current feedback field-effect transistor Q3;
A drain of the second enhanced NMOS transistor Q5 is connected to a gate of the second depletion NMOS transistor Q2 and one end of a fourth resistor R4, and the other end of the fourth resistor R4 is connected to a drain of the current feedback field-effect transistor Q3.

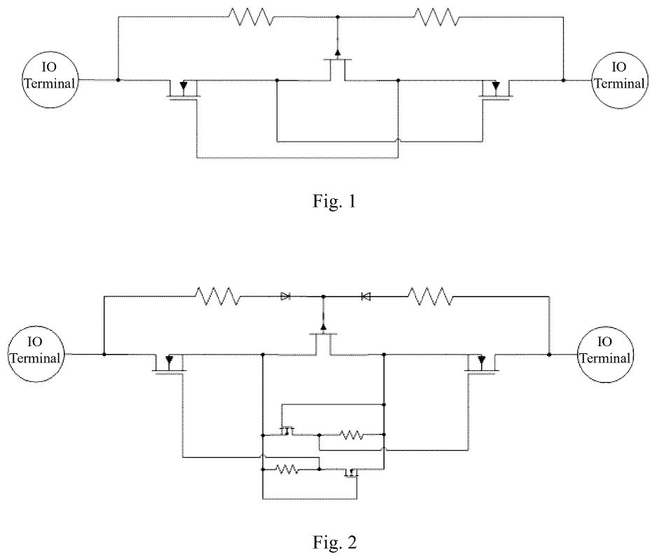

Specifically, there exists a BSP circuit in the prior art, wherein a basic framework of a blocking circuit is constructed by utilizing common semiconductor devices such as depletion NMOS transistors and current feedback field-effect transistors. Through the control of the gate of the depletion NMOS transistor by the current feedback field-effect transistor, when the line current reaches the trigger current, the BSP circuit switches from conduction to shut-off, thereby achieving surge blocking protection. The circuit is shown in FIG. 1.

In the prior art, there also exists a BSP circuit incorporating an enhanced NMOS device. The main concept involves utilizing the relatively stable threshold voltage characteristic of the enhanced NMOS to control the switching state of the depletion NMOS gate circuit, thereby addressing the issue of BSP circuit trigger current dispersion caused by the inherent instability in the threshold voltage due to the manufacturing process of depletion NMOS. The circuit is shown in FIG. 2.

However, when considering application scenarios such as automotive environments where significant temperature variations occur, the aforementioned existing circuits exhibit the problem of trigger current fluctuations with temperature changes.

For the first existing circuit, when the temperature gradually increases from room temperature (25° C.), the on-resistance of the current feedback field-effect transistor increases due to its positive temperature coefficient, resulting in a corresponding decrease in the overall BSP circuit trigger current. Conversely, when the temperature gradually decreases, the trigger current increases accordingly. The trigger current of this BSP circuit exhibits a negative temperature coefficient.

For the second existing circuit, when the temperature gradually increases from room temperature (25° C.), the threshold voltage of the enhanced NMOS responsible for controlling the gate state of the depletion NMOS decreases due to its negative temperature coefficient. Consequently, the enhanced NMOS switches to the on-state even at a lower trigger current of the BSP, causing the depletion NMOS gate to receive a potential signal and transition to the blocking state. This ultimately manifests as a rapid decrease in the overall BSP circuit trigger current with rising temperature. Conversely, when the temperature gradually decreases, the threshold voltage of the enhanced NMOS increases, leading to a rapid increase in the trigger current. The trigger current of this BSP circuit exhibits a more pronounced negative temperature coefficient.

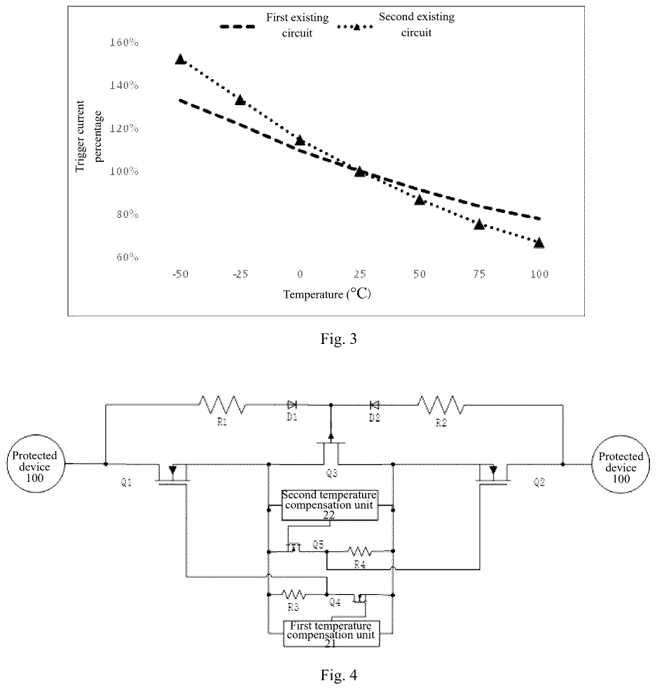

FIG. 3 shows the percentage change in trigger current relative to that at room temperature (25° C.) for the aforementioned existing circuits over a temperature range of −50° C. to 100° C. The variation range of the trigger current for the first existing circuit is 78% to 133%. The variation range of the trigger current for the second existing circuit is 67% to 152%. It can be seen that the temperature stability of the trigger current in the second existing circuit further deteriorates compared to the first existing circuit due to the added enhanced NMOS circuitry.

In this embodiment of the present invention, a block surge protector with temperature compensation is designed. The schematic diagram is shown in FIG. 4, wherein a temperature compensation unit 2 is added to the BSP circuit. The temperature compensation unit 2 is connected in parallel across the drain-source terminals of the current feedback field-effect transistor Q3 (using a P-type JFET) to capture potential signals. It internally processes the potential signals and transmits them to the gates of the enhanced NMOS transistors Q4/Q5 to control the switching states of the enhanced NMOS transistors Q4/Q5.

The potential transmitted by the temperature compensation unit 2 to the gates of the enhanced NMOS transistors Q4/Q5 exhibits a negative temperature coefficient. This characteristic matches the negative temperature coefficient of the threshold voltage of the gates of the enhanced NMOS transistors Q4/Q5 and the positive temperature coefficient of the on-resistance of the current feedback field-effect transistor. The specific temperature compensation principle is as follows:

Case 1: At room temperature (25° C.), the temperature compensation unit 2 collects a voltage signal from the drain-source terminals of the current feedback field-effect transistor Q3 and transmits it to the gates of the enhanced NMOS transistors Q4/Q5. When the BSP current reaches the trigger current, the voltage transmitted by the temperature compensation unit 2 to the gates of the enhanced NMOS transistors Q4/Q5 reaches their threshold voltage, causing the enhanced NMOS transistors Q4/Q5 to turn on and control the depletion NMOS transistors Q1/Q2 to turn off, thereby achieving the blocking characteristic. The trigger current at this temperature is the reference current.

Case 2: When the temperature increases, the on-resistance of the current feedback field-effect transistor Q3 increases (positive temperature coefficient), and the threshold voltage of the enhanced NMOS transistors Q4/Q5 decreases (negative temperature coefficient). At this time, although the voltage signal collected by the temperature compensation unit 2 from the drain-source terminals of the current feedback field-effect transistor Q3 increases, due to its own negative temperature coefficient, the voltage signal transmitted by the temperature compensation unit 2 to the gates of the enhanced NMOS transistors Q4/Q5 instead decreases as the temperature rises, and the magnitude of this decrease matches the reduction in the threshold voltage of the enhanced NMOS transistors Q4/Q5. Therefore, only when the BSP current still reaches the room-temperature reference current will the temperature compensation unit 2 turn on the enhanced NMOS transistors Q4/Q5, thereby controlling the depletion NMOS transistors Q1/Q2 to turn off and achieving the blocking characteristic. Thus, although the temperature increases, the trigger current of the BSP circuit remains the same as at room temperature.

Case 3: When the temperature decreases, the on-resistance of the current feedback field-effect transistor Q3 decreases (positive temperature coefficient), and the threshold voltage of the enhanced NMOS transistors Q4/Q5 increases (negative temperature coefficient). At this time, although the voltage signal collected by the temperature compensation unit 2 from the drain-source terminals of the current feedback field-effect transistor Q3 decreases, due to its own negative temperature coefficient, the voltage signal transmitted by the temperature compensation unit 2 to the gates of the enhanced NMOS transistors Q4/Q5 instead increases as the temperature decreases, and the magnitude of this increase matches the increase in the threshold voltage of the enhanced NMOS transistors Q4/Q5. Therefore, only when the BSP current still reaches the room-temperature reference current will the temperature compensation unit 2 turn on the enhanced NMOS transistors Q4/Q5 and control the depletion NMOS transistors Q1/Q2 to turn off, thereby achieving the blocking characteristic. Thus, although the temperature decreases, the trigger current of the BSP circuit remains the same as at room temperature.

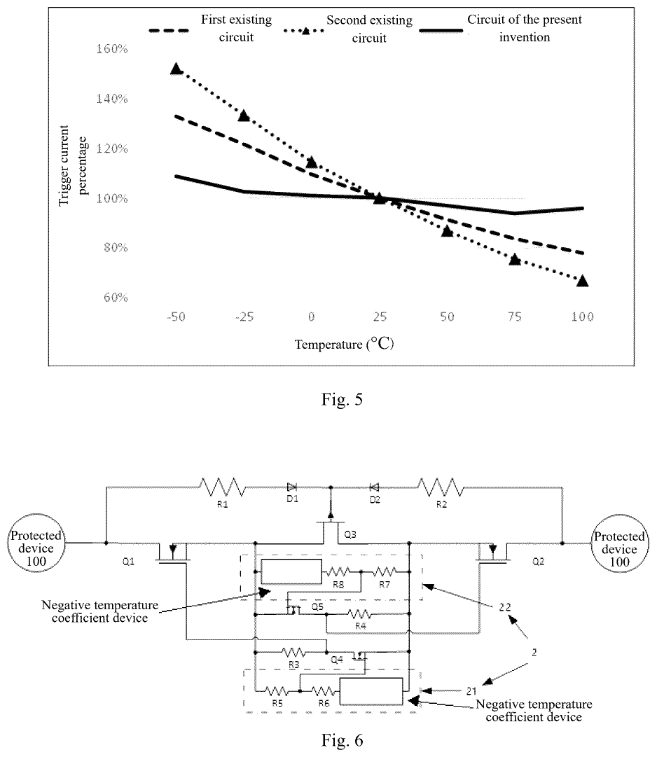

As shown in FIG. 5, the fluctuation percentages of the trigger current relative to the room-temperature (25° C.) reference trigger current are illustrated for Existing Circuit 1, Existing Circuit 2, and the present invention under ambient temperatures ranging from −50° C. to 100° C. The variation range of the trigger current for Existing Circuit 1 is 78% to 133%, the variation range of the trigger current for Existing Circuit 2 is 67% to 152%, while the variation range of the trigger current of the circuit of the present invention is only 96% to 109%, indicating a significant reduction in fluctuation range. It is evident that the circuit of the present invention achieves excellent temperature stability.

In summary, it can be concluded that the block surge protector with temperature compensation of the present invention comprises the following three advantages:
1. compared with the first existing circuit and the second existing circuit, it maintains the surge protection effect of the blocking characteristic unchanged;
2. compared with the second existing circuit, it retains the function of the enhanced NMOS circuit to solve the dispersion of the BSP circuit trigger current caused by the instability of the threshold voltage of the depletion NMOS transistor;
3. it significantly improves the temperature stability of the overall BSP circuit trigger current and reduces the magnitude of variation of the trigger current with temperature changes.

### Embodiment 2

This embodiment, based on Embodiment 1, specifically describes the structure in the temperature compensation unit 2, comprising:
a negative temperature coefficient device, one end of the negative temperature coefficient device is connected to one end of the current feedback field-effect transistor Q3, and the other end of the negative temperature coefficient device is sequentially connected in series with a pull-up resistor and a voltage division resistor;
the other end of the current feedback field-effect transistor is connected to the voltage division resistor, and the gate of the enhanced NMOS transistor is connected to a connection point between the voltage division resistor and the pull-up resistor.

Specifically, as shown in FIG. 6, since the present invention illustrates a bidirectional surge protection circuit with symmetrical and identical circuit designs in both directions, only one temperature compensation unit will be described hereafter.

Taking the first temperature compensation unit 21 as an example, the temperature compensation unit 21 is composed of a resistor R5, a resistor R6, and a negative temperature coefficient device. The gate of the enhanced NMOS transistor Q4 directly receives a voltage signal from the resistor R5 and the resistor R6. Here, the resistor R5 is a voltage division resistor, and the resistor R6 is a pull-up resistor for the gate of the enhanced NMOS transistor Q4. Similarly, in the second temperature compensation unit 22, the resistor R7 is a voltage division resistor, and the resistor R8 is a pull-up resistor for the gate of the second enhanced NMOS transistor Q5.

The specific temperature compensation principle is as follows.

Case 1: At room temperature (25° C.), the temperature compensation unit 2 collects a voltage signal from the drain-source terminals of the current feedback field-effect transistor Q3 and transmits it to the gates of the enhanced NMOS transistors Q4/Q5. When the BSP current reaches the trigger current, the voltage transmitted by the temperature compensation unit 2 to the gates of the enhanced NMOS transistors Q4/Q5 reaches their threshold voltage, causing the enhanced NMOS transistors Q4/Q5 to turn on and control the depletion NMOS transistors Q1/Q2 to turn off, thereby achieving the blocking characteristic. The trigger current at this temperature is the reference current.

Case 2: When the temperature increases, the on-resistance of the current feedback field-effect transistor Q3 increases (positive temperature coefficient), and the threshold voltage of the enhanced NMOS transistors Q4/Q5 decreases (negative temperature coefficient). At this time, although the voltage signal collected by the temperature compensation unit 2 from the drain-source terminals of the current feedback field-effect transistor Q3 increases, due to the negative temperature coefficient of the negative temperature coefficient device therein, the overall voltage division between the pull-up resistor R6 and the negative temperature coefficient device decreases. Consequently, the voltage signal transmitted by the temperature compensation unit 2 to the gates of the enhanced NMOS transistors Q4/Q5 instead decreases as the temperature rises, and the magnitude of this decrease matches the reduction in the threshold voltage of the enhanced NMOS transistors Q4/Q5. Therefore, only when the BSP current still reaches the room-temperature reference current will the temperature compensation unit 2 turn on the enhanced NMOS transistors Q4/Q5, thereby controlling the depletion NMOS transistors Q1/Q2 to turn off and achieving the blocking characteristic. Thus, although the temperature increases, the trigger current of the BSP circuit remains the same as at room temperature.

Case 3: When the temperature decreases, the on-resistance of the current feedback field-effect transistor Q3 decreases (positive temperature coefficient), and the threshold voltage of the enhanced NMOS transistors Q4/Q5 increases (negative temperature coefficient). At this time, although the voltage signal collected by the temperature compensation unit 2 from the drain-source terminals of the current feedback field-effect transistor Q3 decreases, due to the negative temperature coefficient of the negative temperature coefficient device therein, the overall voltage division between the pull-up resistor R6 and the negative temperature coefficient device increases. Consequently, the voltage signal transmitted by the temperature compensation unit 2 to the gates of the enhanced NMOS transistors Q4/Q5 instead increases as the temperature decreases, and the magnitude of this increase matches the increase in the threshold voltage of the enhanced NMOS transistors Q4/Q5. Therefore, only when the BSP current still reaches the room-temperature reference current will the temperature compensation unit 2 turn on the enhanced NMOS transistors Q4/Q5 and control the depletion NMOS transistors Q1/Q2 to turn off, thereby achieving the blocking characteristic. Thus, although the temperature decreases, the trigger current of the BSP circuit remains the same as at room temperature.

### Embodiment 3

The present embodiment, based on Embodiment 2, specifically describes the structure of the negative temperature coefficient device. The negative temperature coefficient device is preferably a diode, a transistor BE junction, a transistor BC junction, or a negative temperature coefficient thermistor.

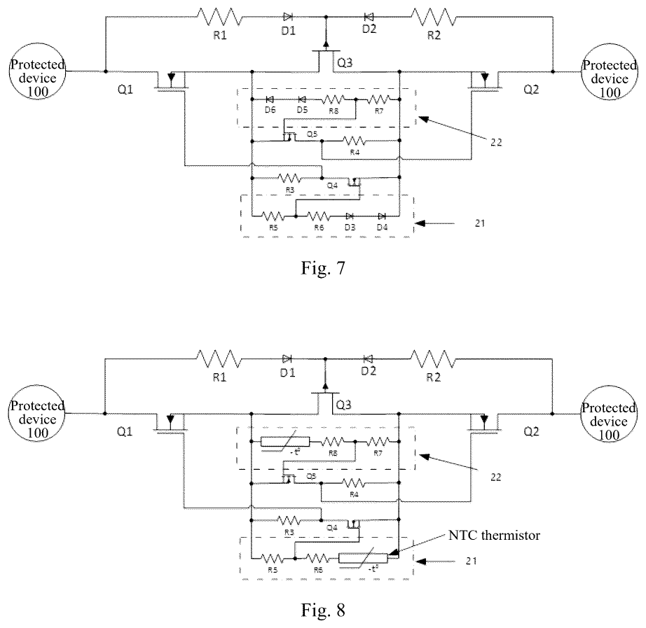

In this embodiment, taking diodes as an example, as shown in FIG. 7, the negative temperature coefficient device in the first temperature compensation unit 21 comprises a plurality of diodes D3, D4 with anodes and cathodes connected sequentially in series;

The cathode side of diode D4 is connected to one end of the current feedback field-effect transistor Q3, and the cathode side of diode D3 is connected to the pull-up resistor R6.

Specifically, in this embodiment, the negative temperature coefficient devices of the first temperature compensation unit 21 and the second temperature compensation unit 22 are constructed using diodes. The diodes here may be one or multiple connected in series, with a preferred number of 1 to 3 diodes in series. This embodiment utilizes the negative temperature coefficient of the forward conduction voltage of diodes. By means of the voltage division relationship among the resistor R5, the resistor R6, and the forward voltage drop of the diode string D3, D4, the voltage signal transmitted to the gate of the first enhanced NMOS transistor Q4 is adjusted under different temperatures.

Specifically, when the temperature rises above room temperature, the forward conduction voltage drop of diodes D3 and D4 decreases, and the threshold voltage of the enhanced NMOS transistor Q4 decreases. At this time, the overall voltage division between resistor R6 and diodes D3, D4 is reduced, resulting in a lower voltage transmitted to the gate of the enhanced NMOS transistor Q4. This voltage reduction offsets the decrease in the threshold voltage of the enhanced NMOS transistor Q4. Therefore, for the overall BSP circuit, the current must still reach the trigger current at room temperature to enter the blocking state.

When the temperature decreases below room temperature, the forward conduction voltage drop of diodes D3 and D4 increases, and the threshold voltage of the enhanced NMOS transistor Q4 increases. At this time, the overall voltage division between resistor R6 and diodes D3, D4 increases, resulting in a higher voltage transmitted to the gate of the enhanced NMOS transistor Q4. This voltage increase offsets the rise in the threshold voltage of the enhanced NMOS transistor Q4. Therefore, for the overall BSP circuit, the current must still reach the trigger current at room temperature to enter the blocking state.

Therefore, the above embodiment can maintain the stability of the circuit trigger current during temperature variations.

### Embodiment 4

This embodiment is another embodiment proposed based on Embodiment 2, as shown in FIG. 8.

Specifically, in this embodiment, the negative temperature coefficient device of the temperature compensation unit 2 is constructed using an NTC thermistor. This embodiment utilizes the negative temperature coefficient of the resistance of the NTC thermistor. By means of the voltage division relationship among the resistor R5, the resistor R6, and the NTC thermistor, the voltage signal transmitted to the gates of the enhanced NMOS transistors Q4/Q5 is adjusted under different temperatures. Its working process is similar to that of Embodiment 3 and will not be repeated here.

### Embodiment 5

In this embodiment, also based on Embodiment 2, the structure of the temperature compensation unit is specifically described, comprising:
a positive temperature coefficient device, one end of the positive temperature coefficient device is connected to one end of the current feedback field-effect transistor Q3, and the other end of the positive temperature coefficient device is sequentially connected in series with a voltage division resistor and a pull-up resistor;
the other end of the current feedback field-effect transistor Q3 is connected to the pull-up resistor, and the gate of the enhanced NMOS transistor is connected to a connection point between the voltage division resistor and the pull-up resistor.

Preferably, the positive temperature coefficient device is a positive temperature coefficient thermistor, or a field-effect transistor on-resistance, or a metal film resistor, or a polysilicon resistor.

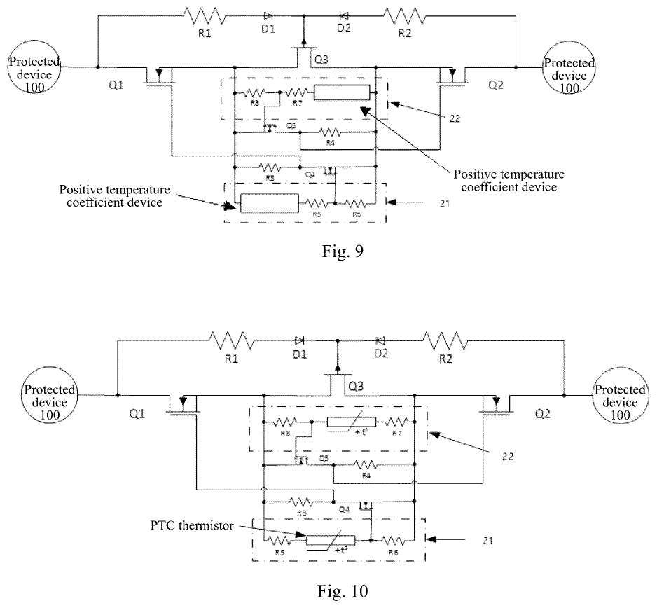

Specifically, as shown in FIG. 9, since the present invention illustrates a bidirectional surge protection circuit with symmetrical and identical circuit designs in both directions, only one temperature compensation unit will be described hereafter.

Taking the first temperature compensation unit 21 as an example, the first temperature compensation unit 21 is composed of a resistor R5, a resistor R6, and a positive temperature coefficient device. The gate of the enhanced NMOS transistor Q4 similarly receives a voltage signal from between the resistor R5 and the resistor R6. Here, the resistor R5 is a voltage division resistor, and the resistor R6 is a pull-up resistor for the gate of the enhanced NMOS transistor Q4. Similarly, in the second temperature compensation unit 22, the resistor R7 is a voltage division resistor, and the resistor R8 is a pull-up resistor for the gate of the second enhanced NMOS transistor Q5. The positive temperature coefficient device may be a PTC thermistor, a field-effect transistor on-resistance, a metal film resistor, a polysilicon resistor, or the like.

The specific temperature compensation principle is as follows:

Case 1: At room temperature (25° C.), the temperature compensation unit 2 collects a voltage signal from the drain-source terminals of the current feedback field-effect transistor Q3 and transmits it to the gates of the enhanced NMOS transistors Q4/Q5. When the BSP current reaches the trigger current, the voltage transmitted by the temperature compensation unit 2 to the gates of the enhanced NMOS transistors Q4/Q5 reaches their threshold voltage, causing the enhanced NMOS transistors Q4/Q5 to turn on and control the depletion NMOS transistors Q1/Q2 to turn off, thereby achieving the blocking characteristic. The trigger current at this temperature is the reference current.

Case 2: When the temperature increases, the on-resistance of the current feedback field-effect transistor Q3 increases (positive temperature coefficient), and the threshold voltage of the enhanced NMOS transistors Q4/Q5 decreases (negative temperature coefficient). At this time, although the voltage signal collected by the temperature compensation unit 2 from the drain-source terminals of the current feedback field-effect transistor Q3 increases, due to the positive temperature coefficient of the positive temperature coefficient device therein, the overall voltage division between the voltage division resistor R5 and the positive temperature coefficient device increases, while the voltage division of the pull-up resistor R6 decreases. Consequently, the voltage signal transmitted by the temperature compensation unit 2 to the gates of the enhanced NMOS transistors Q4/Q5 instead decreases as the temperature rises, and the magnitude of this decrease matches the reduction in the threshold voltage of the enhanced NMOS transistors Q4/Q5. Therefore, only when the BSP current still reaches the room-temperature reference current will the temperature compensation unit 2 turn on the enhanced NMOS transistors Q4/Q5, thereby controlling the depletion NMOS transistors Q1/Q2 to turn off and achieving the blocking characteristic. Thus, although the temperature increases, the trigger current of the BSP circuit remains the same as at room temperature.

Case 3: When the temperature decreases, the on-resistance of the current feedback field-effect transistor Q3 decreases (positive temperature coefficient), and the threshold voltage of the enhanced NMOS transistors Q4/Q5 increases (negative temperature coefficient). At this time, although the voltage signal collected by the temperature compensation unit 2 from the drain-source terminals of the current feedback field-effect transistor Q3 decreases, due to the positive temperature coefficient of the positive temperature coefficient device therein, the overall voltage division between the voltage division resistor R5 and the positive temperature coefficient device decreases, while the voltage division of the pull-up resistor R6 increases. Consequently, the voltage signal transmitted by the temperature compensation unit 2 to the gates of the enhanced NMOS transistors Q4/Q5 instead increases as the temperature decreases, and the magnitude of this increase matches the increase in the threshold voltage of the enhanced NMOS transistors Q4/Q5. Therefore, only when the BSP current still reaches the room-temperature reference current will the temperature compensation unit 2 turn on the enhanced NMOS transistors Q4/Q5 and control the depletion NMOS transistors Q1/Q2 to turn off, thereby achieving the blocking characteristic. Thus, although the temperature decreases, the trigger current of the BSP circuit remains the same as at room temperature.

### Embodiment 6

Based on Embodiment 2, the adopted temperature compensation unit comprises:
a positive temperature coefficient thermistor, wherein two ends of the positive temperature coefficient thermistor are connected to a voltage division resistor and a pull-up resistor respectively;
one end of the current feedback field-effect transistor Q3 is connected to the pull-up resistor, the other end of the current feedback field-effect transistor is connected to the voltage division resistor, and the gate of the enhanced NMOS transistor Q4/Q5 is connected to a connection point between the positive temperature coefficient thermistor and the pull-up resistor.

Herein, the resistor R5 is a voltage division resistor, and the resistor R6 is a pull-up resistor for the gate of the enhanced NMOS transistor Q4. Similarly, in the second temperature compensation unit 22, the resistor R7 is a voltage division resistor, and the resistor R8 is a pull-up resistor for the gate of the second enhanced NMOS transistor Q5.

Specifically, in this embodiment, the positive temperature coefficient device of the temperature compensation unit 2 is constructed using a PTC thermistor. Unlike in Embodiment 4, the gate of the enhanced NMOS transistor Q4 in this embodiment collects only the voltage of the pull-up resistor R6. This embodiment utilizes the PTC thermistor to adjust the voltage division of the pull-up resistor R6. Therefore, as shown in FIG. 10, the PTC thermistor is placed on the left side of the connection point of the gate of the enhanced NMOS transistor Q4, rather than on the right side. This embodiment leverages the positive temperature coefficient of the resistance of the PTC thermistor. By means of the voltage division relationship among the resistor R5, the resistor R6, and the PTC thermistor, the voltage signal transmitted to the gate of the enhanced NMOS transistor Q4 is adjusted under different temperatures. Its working process is similar to that of Embodiment 5 and will not be repeated here.

The foregoing describes only preferred embodiments of the invention, which therefore do not limit its embodiments or scope of protection. Those skilled in the art should recognize that all solutions obtained through equivalent substitutions or obvious modifications based on the specification and drawings of this invention shall fall within its protective scope.

1. A block surge protector with temperature compensation, comprising:
a bidirectional surge protection circuit, wherein bidirectional wiring terminals of the bidirectional surge protection circuit are connected in series between two protected devices;
a temperature compensation unit, wherein a signal acquisition terminal of the temperature compensation unit is connected in parallel across a source and a drain of a current feedback field-effect transistor in the bidirectional surge protection circuit, and a conduction control terminal of the temperature compensation unit is connected to a gate of an enhanced NMOS transistor in the bidirectional surge protection circuit, configured to adjust a collected voltage signal to match a threshold voltage of the enhanced NMOS transistor according to temperature variations when generating a transient voltage so as to realize conduction, and further to control a depletion NMOS transistor connected to the protected devices to turn off so as to realize surge blocking protection.

2. The block surge protector of claim 1, wherein the temperature compensation unit comprises:
a negative temperature coefficient device, one end of the negative temperature coefficient device is connected to one end of the current feedback field-effect transistor, and the other end of the negative temperature coefficient device is sequentially connected in series with a pull-up resistor and a voltage division resistor;
the other end of the current feedback field-effect transistor is connected to the voltage division resistor, and the gate of the enhanced NMOS transistor is connected to a connection point between the voltage division resistor and the pull-up resistor.

3. The block surge protector of claim 2, wherein the negative temperature coefficient device comprises a plurality of diodes with anodes and cathodes connected sequentially in series;
the cathode side of the diodes is connected to one end of the current feedback field-effect transistor, and the anode side of the diodes is connected to the pull-up resistor.

4. The block surge protector of claim 3, wherein the number of diodes is 1 to 3.

5. The block surge protector of claim 2, wherein the negative temperature coefficient device is a diode, or a transistor BE junction, or a transistor BC junction, or a negative temperature coefficient thermistor.

6. The block surge protector of claim 1, wherein the temperature compensation unit comprises:
a positive temperature coefficient device, one end of the positive temperature coefficient device is connected to one end of the current feedback field-effect transistor, and the other end of the positive temperature coefficient device is sequentially connected in series with a voltage division resistor and a pull-up resistor;
the other end of the current feedback field-effect transistor is connected to the pull-up resistor, and the gate of the enhanced NMOS transistor is connected to a connection point between the voltage division resistor and the pull-up resistor.

7. The block surge protector of claim 6, wherein the positive temperature coefficient device is a positive temperature coefficient thermistor, or a field-effect transistor on-resistance, or a metal film resistor, or a polysilicon resistor.

8. The block surge protector of claim 1, wherein the temperature compensation unit comprises:
a positive temperature coefficient thermistor, wherein two ends of the positive temperature coefficient thermistor are connected to a voltage division resistor and a pull-up resistor respectively;
one end of the current feedback field-effect transistor is connected to the pull-up resistor, the other end of the current feedback field-effect transistor is connected to the voltage division resistor, and the gate of the enhanced NMOS transistor is connected to a connection point between the positive temperature coefficient thermistor and the pull-up resistor.

9. The block surge protector of claim 1, wherein the depletion NMOS transistor in the bidirectional surge protection circuit comprises a first depletion NMOS transistor and a second depletion NMOS transistor;
a drain and a source of the current feedback field-effect transistor are connected to a source of the first depletion NMOS transistor and a source of the second depletion NMOS transistor respectively, a gate of the current feedback field-effect transistor is connected to a cathode of a first diode and a cathode of a second diode, an anode of the first diode is connected in series with a drain of the first depletion NMOS transistor via a first resistor, and an anode of the second diode is connected in series with a drain of the second depletion NMOS transistor via a second resistor;
the drain of the first depletion NMOS transistor and the drain of the second depletion NMOS transistor are connected to a protected device respectively.

10. The block surge protector of claim 9, wherein the enhanced NMOS transistor in the bidirectional surge protection circuit comprises a first enhanced NMOS transistor and a second enhanced NMOS transistor, and the temperature compensation unit comprises a first temperature compensation unit and a second temperature compensation unit;
a source of the first enhanced NMOS transistor and a source of the second enhanced NMOS transistor are connected to a drain and a source of the current feedback field-effect transistor respectively, a gate of the first enhanced NMOS transistor is connected to a conduction control terminal of the first temperature compensation unit, and a gate of the second enhanced NMOS transistor is connected to a conduction control terminal of the second temperature compensation unit;
a drain of the first enhanced NMOS transistor is connected to a gate of the first depletion NMOS transistor and one end of a third resistor, and the other end of the third resistor is connected to the source of the current feedback field-effect transistor;
a drain of the second enhanced NMOS transistor is connected to a gate of the second depletion NMOS transistor and one end of a fourth resistor, and the other end of the fourth resistor is connected to the drain of the current feedback field-effect transistor.
